(19) United States
(12) Patent Application Publication
(10) Pub. No.: US 2005/0114584 A1
(43) Pub. Date: May 26, 2005

(54) Multimedia access device

(76) Inventor: Chin-Lung Chen, Taipei (TW)

Correspondence Address: SUPREME PATENT SERVICES, POST OFFICE BOX 2339, SARATOGA, CA, 95070, US

(21) Appl. No.: 10/706,359

(22) Filed: Nov. 11, 2003

(51) Int. Cl. G06F 13/00

(52) U.S. Cl. 710/313; 711/115; 710/304

(57) ABSTRACT

A multimedia access device with a multiple access memory structure includes a main board, a first card slot, a second card slot, one or more HUB connector and a disk read mechanism, wherein the main board is provided with one or more USB (Universal Serial Bus) pocket disk memory; the first card slot, the second card slot and HUB connectors are mounted to and electrically connected to the main board; the disk read mechanism is then assembled to and electrically connected to the top of the main board to form the multimedia access device. The multimedia access device of the present invention with a function of USB pocket disk can access the data of a floppy disk and various memory cards and can connect with other electronic memory equipments through the HUB connectors for effectively expanding the memory capacities thereof.

### BACKGROUND OF THE INVENTION

1. Field of the Invention

The present invention relates to a multimedia access device with a multiple access memory structure, which is suitable to access the data of various memory cards and a floppy disk and is able to connect with other electronic memory equipments for using data in common.

2. The Related Art

The developments and applications of computers and electronic equipments have a significant effect on communication, information transmission and economic development. Many peripheral devices incorporated with computers and electronic equipments are used. Some devices bring convenience, but the other devices have limits in use. For example, a USB (Universal Serial Bus) pocket disk, which has a large memory capacity and is ready to carry, can be directly plugged into a UBS connector of a computer or electronic equipment for access of the data stored in the USB pocket disk. That is very convenient in use. Moreover, various card readers are available and each is only suitable for data access of a specific type of memory card. A card reader used for Smart Media card, Secure Digital card, Multi-Media card, XD-picture card and Memory Stick card cannot be generally suitable for Compact Flash card and Micro Drive card. A card reader used for memory cards cannot access the data stored in a 3.5-inch floppy disk that is accessible by a floppy disk drive.

The above-mentioned devices of USB pocket disk, card readers and floppy drive are designed to a single-use for one machine. If it needs to use various memory media or memory cards, various card readers must be installed. Since there are a variety of different specification memory cards, for example Smart Media card, Secure Digital card, Multi-Media card, Compact Flash card and Micro Drive card, it is quite troublesome for a general consumer to prepare and install various specification card readers except space occupations. That also causes a waste of money in addition to inconvenience in use.

### SUMMARY OF THE INVENTION

Since there are various electronic memory equipments and memory cards, that causes an inconvenience in use. The present invention proposes to integrate a USB pocket disk, various card readers and a floppy drive to form a more practical multimedia access device with a function of USB pocket disk, which can access the data of various memory cards and a floppy disk and can connect with other electronic memory equipments through HUB connectors.

A multimedia access device according to the present invention comprises a main board, a first card slot, a second card slot, one or more HUB connector and a disk read mechanism, wherein the main board is provided with one or more USB pocket disk memory; the first card slot, second card slot and HUB connectors are mounted to and electrically connected to the main board; and the disk read mechanism is assembled to and electrically connected to the top of the main board to form the multimedia access device.

In comparison with conventional access devices, the multimedia access device of the present invention having a function of USB pocket disk can access the data of the currently used floppy disk and various memory cards, for example Smart Media card, Secure Digital card, Multi-Media card, XD-picture card and Memory Stick card, Compact Flash card and Micro Drive card, and can connect with other electronic memory equipments through the HUB connectors for using data in common and expanding the memory capacities thereof.

### BRIEF DESCRIPTION OF THE DRAWINGS

FIG. 1 is a perspective view of a multimedia access device of a preferred embodiment according to the present invention;

FIG. 2 is an exploded view of the multimedia access device of the present invention;

FIG. 3 is a partly exploded view of the multimedia access device of the present invention; and

FIG. 4 is another partly exploded view of the multimedia access device of the present invention.

### DETAILED DESCRIPTION OF THE PREFERRED EMBODIMENT

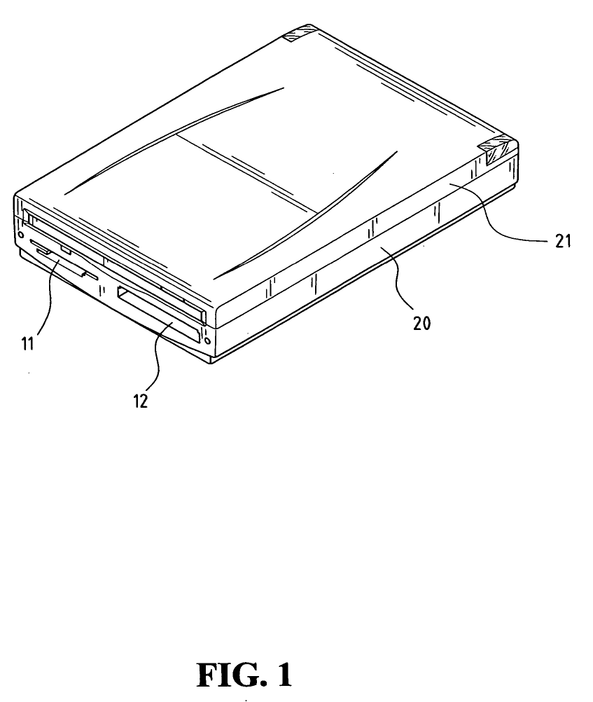

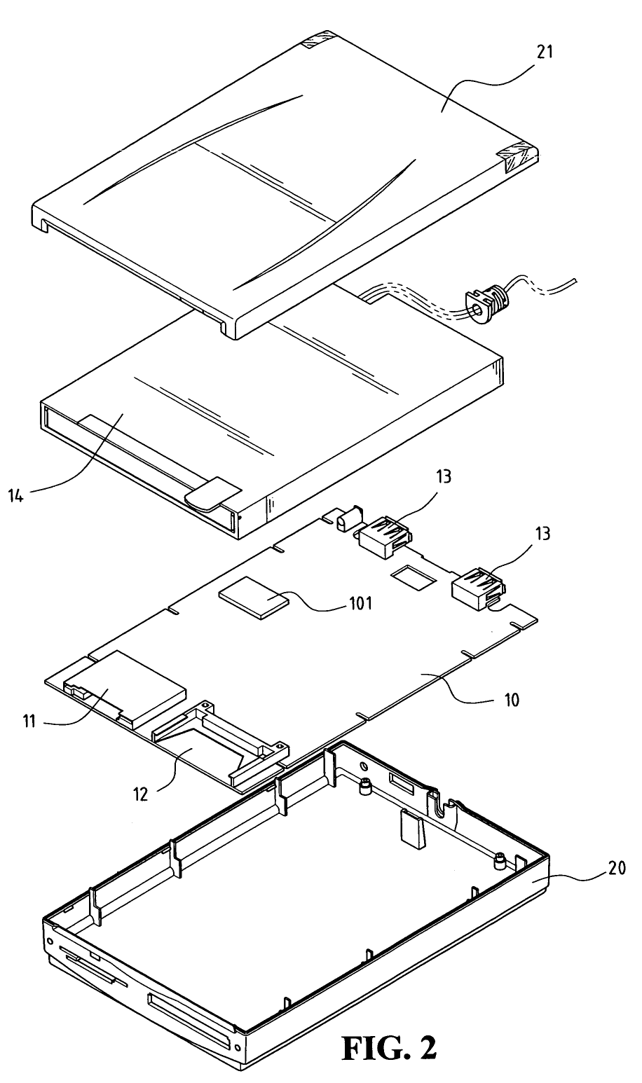

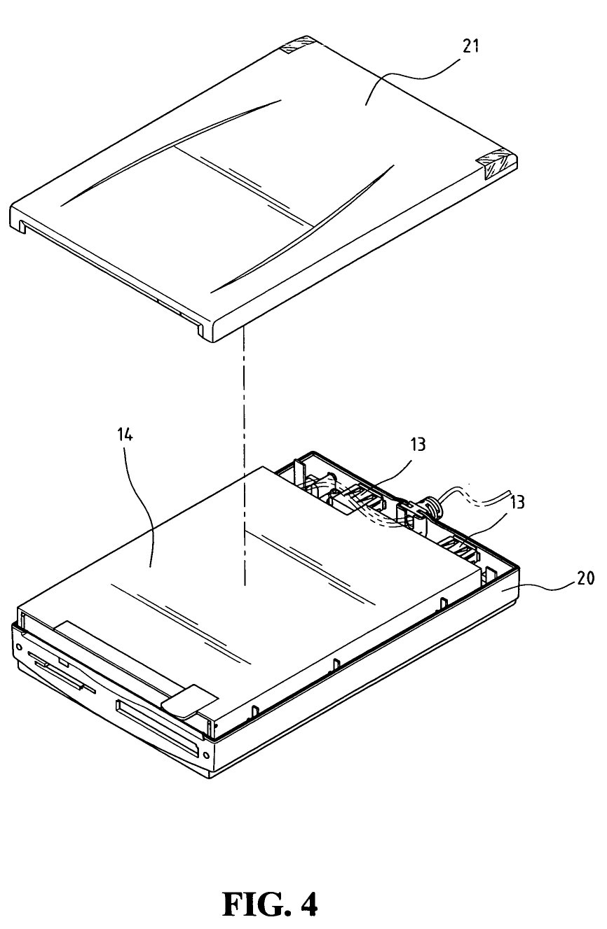

With reference to the drawings and in particular to FIGS. 1-4, a multimedia access device in accordance with the present invention comprises a main board 10, a first card slot 11, a second card slot 12, one or more HUB connector 13 and a disk read mechanism 14. The main board 10 is provided with one or more USB (Universal Serial Bus) pocket disk memory 101. The first card slot 11, which open is outward, is mounted to and electrically connected to a side of the main board 10. The first card slot 11 is suitable to access the data of memory cards for example Smart Media card, Secure Digital card, Multi-Media card, XD-picture card and Memory Stick card. The second card slot 12, which open is outward, is mounted to and electrically connected to a side of the main board 10. The second card slot 12 is suitable to access the data of memory cards for example Compact Flash card and Micro Drive card. The one or more HUB connector 13 is mounted to and electrically connected to the other side of the main board 10. The disk read mechanism 14 is assembled to and electrically connected to the top of the main board 10. In the preferred embodiment of the present invention, the disk read mechanism 14 is a 3.5-inch floppy drive.

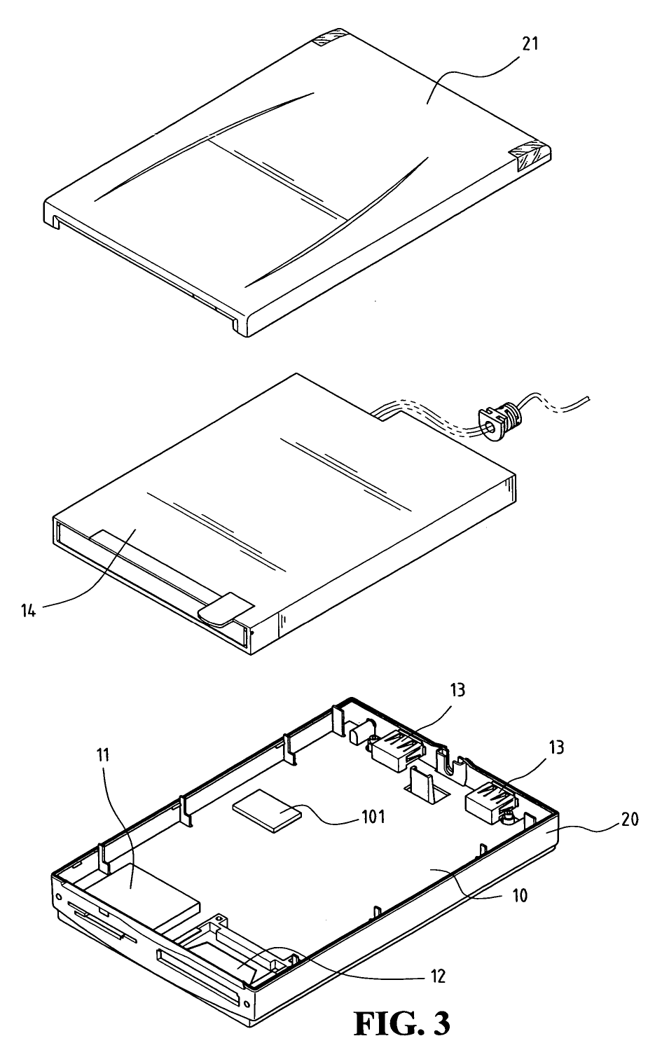

Referring to FIG. 3, in assembling, the first card slot 11, the second card slot 12 and the HUB connector 13 are respectively mounted onto the main board 10; the main board 10 is then in whole embedded and assembled in a receiving housing 20. The disk read mechanism 14 is subsequently embedded in the receiving housing 20 and electrically connected to the main board 10. Finally a top cover 21 is covered thereon to form the multimedia access device.

The above statement is only for illustrating the preferred embodiment of the present invention, and not for giving any limitation to the scope of the present invention. It will be apparent to those skilled in this art that all equivalent modifications and changes shall fall within the scope of the appended claims and are intended to form part of this invention.

1. A multimedia access device comprising a main board, a first card slot, a second card slot, one or more HUB connector and a disk read mechanism, wherein:
the main board is provided with one or more USB (Universal Serial Bus) pocket disk memory;
the first card slot is mounted to and electrically connected to the main board;
the second card slot is mounted to and electrically connected to the main board;
the one or more HUB connector is mounted to and electrically connected to the main board; and
the disk read mechanism is assembled to and electrically connected to the top of the main board.

2. The multimedia access device as claimed in claim 1, wherein the first card slot, the second card slot and the HUB connectors are respectively mounted onto the main board; the main board being then in whole embedded and assembled in a receiving housing; the disk read mechanism being subsequently embedded in the receiving housing and electrically connected to the main board; and finally a top cover being covered thereon to form the multimedia access device.

3. The multimedia access device as claimed in claim 1, wherein the first card slot is suitable to access the data of Smart Media card, Secure Digital card, Multi-Media card, XD-picture card and Memory Stick card.

4. The multimedia access device as claimed in claim 1, wherein the second card slot is suitable to access the data of Compact Flash card and Micro Drive card.

5. The multimedia access device as claimed in claim 1, wherein the disk read mechanism is a 3.5-inch floppy drive.
